(19) United States
(12) Patent Application Publication
(10) Pub. No.: US 2013/0104911 A1
(43) Pub. Date: May 2, 2013

(54) ORAL APPLIANCE

(71) Applicants: JEFFREY S. LUFFEY, Albuquerque, NM (US); Cynthia K. Wright, Santa Fe, NM (US)

(72) Inventors: JEFFREY S. LUFFEY, Albuquerque, NM (US); Cynthia K. Wright, Santa Fe, NM (US)

(21) Appl. No.: 13/286,561

(22) Filed: Nov. 1, 2011

(51) Int. Cl. A61C 5/14

(52) U.S. Cl. 128/860; 128/861

(57) ABSTRACT

An oral appliance is disclosed. The oral appliance may include a body and a bridge connecting left and right side members of the body. The bridge may define a lingual-less open space between the lingual side of the bridge and left and right side members. The space defined by the bridge is configured to accommodate a tongue in a relaxed state.

### BACKGROUND OF THE INVENTION

The present invention generally relates to sleep aids, and more particularly, to an oral appliance.

Snoring and sleep apnea cause a poor night's sleep and may contribute to poor overall health from lack of rest. Sufferers of snoring and sleep apnea may sleep with tensed jaw muscles. The jaw muscles may cause teeth, either upper or lower teeth to sit rearward so that the teeth push the tongue biased toward the rear of the oral cavity. The tongue biased rearward may bunch up obstructing the oral and nasal airways.

As can be seen, there is a need for an oral appliance that can provide a support for relaxed jaws and increased tongue space in the mouth during sleep.

### SUMMARY OF THE INVENTION

In one aspect of the present invention, an oral appliance comprises a molded body including left and right side members, the left and right side members including respectively a member width and lingual-side member walls; and a rounded bridge connecting the left member to the right member, the bridge including a lingual-side bridge wall depressed from the lingual-side member walls, the bridge configured to accommodate a tongue between the lingual-side bridge wall and between the left and right side member walls in a relaxed state, the bridge including a bridge width narrower than the member widths.

In another aspect of the present invention, an oral appliance comprises a one-piece body including dental impressions molded into the body; a left side and a right side of the body defining a first open space of a first radius of curvature between them; and a bridge portion connecting the left side and right side of the body, the bridge portion defining a second open space of a second radius of curvature narrower than the first radius of curvature.

In still yet another aspect of the present invention, an oral appliance comprises a one-piece body including dental impressions molded into the body;

a left side and a right side of the body defining a first open space of a first curvature between them; and a bridge portion connecting the left side and right side of the body, the bridge portion defining a second open space of a second curvature greater than the first curvature.

These and other features, aspects and advantages of the present invention will become better understood with reference to the following drawings, description and claims.

### BRIEF DESCRIPTION OF THE DRAWINGS

FIG. 1 is a perspective view of an oral appliance in accordance with an exemplary embodiment of the present invention shown in use;

FIG. 2 is a front view of the oral appliance of FIG. 1;

FIG. 3 is a perspective view of the oral appliance of FIG. 1; and

FIG. 4 is a cross-section top view of the oral appliance along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide an oral appliance that puts the jaw in relaxed states so that masticating muscles are rested. The oral appliance may control stomatognathic physiology and connections to the central nervous system physiology to decrease snoring and decrease sleep arousals. In one aspect, embodiments of the subject technology may prevent changes in the bite and jaw relationship that current sleep appliances may cause. In one aspect, an oral appliance according to the subject technology may open a user's breathing airway, may increase nasal breathing to enhance respiratory function and can be used with current positive air pressure sleep technology.

Aspects of the subject technology may control the positional relationship of the mandibular and maxillar jaw bones in the mouth by providing an oral appliance customized to the user where the shape and size of the appliance may be configured based on electromyography and computerized jaw tracking systems to find a comfortable and relaxed jaw position that will promote pharyngeal wall integrity and patency. An oral appliance in accordance with exemplary embodiments disclosed herein may reduce sleep arousal triggers to centrally mediated sleep centers of the brain and may assist in keeping the breathing airway open. The pharyngeal and stomatognathic muscles can become fatigued during sleep which increases airway collapsibility. Exemplary embodiments of an oral appliance disclosed herein may also reduce the proprioceptive responses of the tongue, teeth, and jaw musculature that cause sleep arousals. For example, aspects of the oral appliance may reduce these physiological effects that cause the pharyngeal wall collapsibility by reducing the fatigue of muscles of the head and neck due to ascending and descending postural anomalies, opening the airway, and removing proprioceptive neural responses to the sleep centers of the brain.

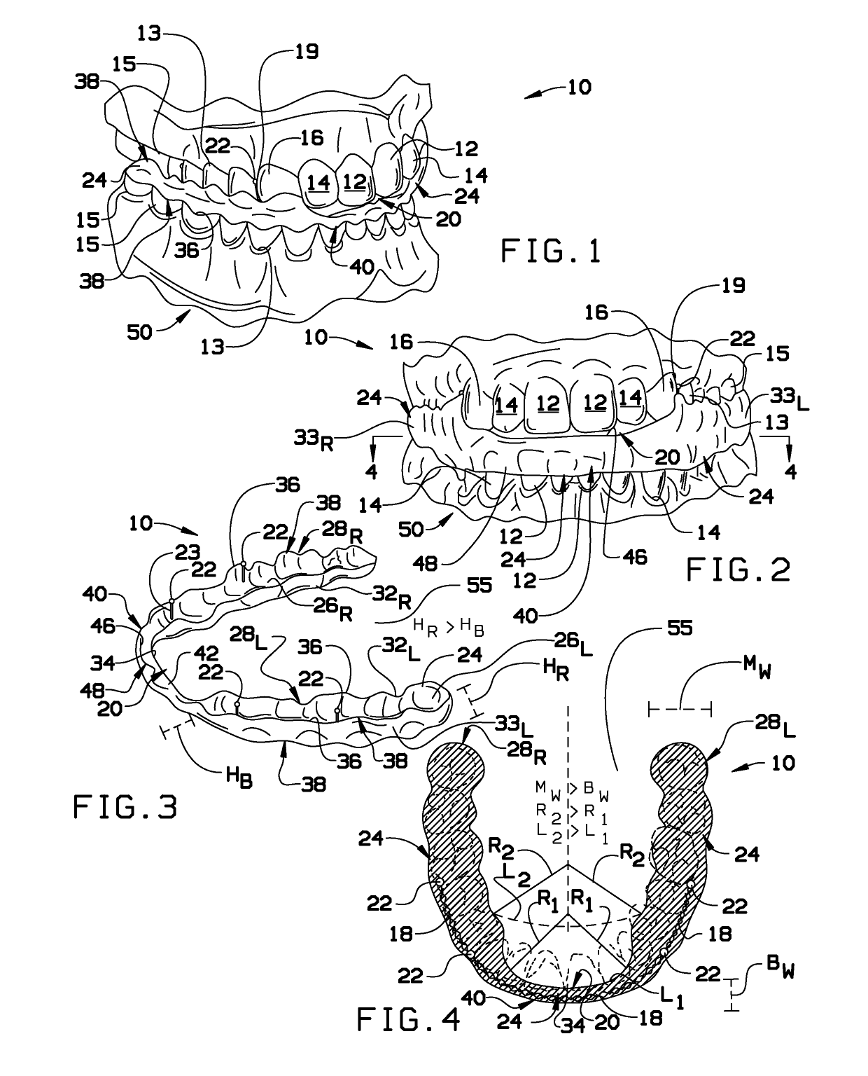

Referring now to FIGS. 1-4, an oral appliance 10 is shown in accordance with exemplary embodiments of the present invention. The oral appliance 10 may be a one-piece molded body 24 of resin or dental acrylic. In one exemplary embodiment of the oral appliance 10, the body 24 may be molded to custom fit a user based on the jaw 50 position of a person (not shown) during sleep or rest. For example, the body 24 may be configured through electromyography muscle potentials (EMG data), computerized jaw tracking technology, and ULF-Transcutaneous Electro-neural Stimulation technology (ULF-TENS) to provide optimal positioning of features on the body 24. Aspects that may be improved by the EMG data, jaw tracking processes, and/or ULF-TENS may include positioning of teeth along the body 24 and the shaping of an anterior tongue space proximate a front end of the body 24. The body 24 may include left and right side members 28_{L} and 28_{R}. It will be understood that elements designated with an “R” may be associated with the right side member 28_{R} and elements designated with an “L” may be associated with the left side member 28_{L}. For example, the left and right side members 28_{L} and 28_{R} may define a typical lingual covered open space 55 found between lingual-side walls 32_{L} and 32_{R}.

In an exemplary embodiment, the left and right side members 28_{L} and 28_{R} may include a set of dental impressions 26_{R} and 26_{L} configured to receive teeth 12; 13; 14; 15; and 16. Impressions 26_{R} and 26_{L} respectively may be molded according to tooth type. For example, the impressions 26_{R} and 26_{L} may be molded based on position along the body 24 to receive an incisor 12;14 (central and lateral types respectively), a cuspid or canine 16, a premolar 13, or a molar 15. The impressions 26_{R} and 26_{L} may also be custom molded for indexed fitting to individual teeth 12; 13; 14; 15; and 16 of the user. Furthermore, dental impressions 26_{R} and 26_{L} may be positioned on either or both the mandibular side or the maxillar side of the body 24. For sake of illustration, features of the oral appliance 10 are shown and described primarily with respect to facing the maxillar side of the jaw 50. However, it will be understood that features of the maxillar side of the body 24 may also be present on the mandibular side unless described otherwise.

The left and right side members 28_{L} and 28_{R} may also include walls 36 projecting from the dental impressions 26_{R} and 26_{L} defining a ridgeline 38 above the dental impressions 26_{R} and 26_{L}. In one exemplary embodiment, the ridgeline 38 may be non-uniform so that the walls 36 partially cover the anterior surfaces of teeth. In an exemplary embodiment, the walls 36 may cover the cuspids 16, pre-molars 13, and molars 15. The ridgeline 38 may define an average height HR of the walls 36. The left and right side members 28_{L} and 28_{R} may also include a width MW defining an average width of spacing between the lingual-side wall (32_{L}; 32_{R}) and a buccal-side wall (33_{L}; 33_{R}).

The body 24 may also include a rounded bridge 40 connecting the left and right side members 28_{L} and 28_{R}. The bridge 40 may be configured to extend between the left and right cuspids 16 and be positioned in support of the incisors 12; 14. The bridge 40 may include a support wall 48 projecting to cover either the mandibular or maxillar side incisors 12; 14. In an exemplary embodiment shown in FIGS. 1 and 2, the support wall 48 is shown at least partially covering the mandibular side incisors 12; 14. However, it will be understood that the support wall 48 may cover either the mandiubular or the maxillar side incisors 12; 14 while leaving the remaining incisor type teeth with exposed anterior surfaces. The support wall 48 may include a ridgeline 46 defining a height profile H_{B} for the bridge 10. The height profile H_{B} may be lower than the height of the ridgeline 36. The bridge 10 may also include a width B_{w}. The width B_{w} may be less than or narrower than the left and right side member widths M_{w}. A shelf 42 on the bridge 40 may be configured to support a tip of the tongue (not shown) on either a mandibular or maxillar side of the bridge 40. The shelf 42 may be lower than and positioned aft of the support wall 48.

The bridge 40, on a lingual-side bridge wall 34 may define an orifice 20 configured to accommodate a tongue (not shown) in a relaxed state between the lingual-side bridge wall 34 and between the left and right side member lingual-side walls 32_{L}; 32_{R}. The curvature of the lingual-side bridge wall 34 may be greater than the curvature between the member lingual-side walls 32_{L}; 32_{R}. For example, the member lingual-side walls 32_{L}; 32_{R} may be configured to follow a natural curve or radius of curvature R₂ of the jaw 50 along the lingual-side of teeth (12; 13; 14; 15; and 16) until the member lingual-side walls 32_{L}; 32_{R} approach the bridge 40. The radius of curvature R₂ may define the curvature of the open space 55 found between the left and right side members 28_{L} and 28_{R}. The radius of curvature R₂ may extend from, for example, a position of the pre-molars 13 to a point approximately equidistant from a centerline running between the left and right side members 28_{L} and 28_{R}. The lingual-side bridge wall 34 may be depressed or scalloped away from the member lingual-side walls 32_{L}; 32_{R} defining a lingual-less open space, the orifice 20. The open space of orifice 20 may be defined by a radius of curvature R₁ that extends from a position of the incisors 14 to a point approximately equidistant from a centerline running between the left and right side members 28_{L} and 28_{R}. In one aspect, the radius of curvature R₂ may be greater than the radius of curvature R₁. In another aspect, an arc angle length L₂ as defined by the arc between radii of curvature R₂ may be greater than an arc length L₁ as defined by that section of the lingual-side bridge wall 34 between radii of curvature R₂.

In another aspect, the oral appliance 10 may be adapted for retention on the jaw 50 by means other than jaw pressure. For example, the oral appliance 10 may include a plurality of dental anchors 22, for example ball clasps 22 mounted onto the body 24. The ball clasps 22 may be attached to posts 23 (FIG. 3) projecting from the body 24. The ball clasps 22 and posts 23 may be connected to a retention wire 18 on or in the body 24 (FIG. 4). The ball clasps 22 may be disposed to latch into crevices 19 between adjacent teeth. FIGS. 1 and 2 for example, show ball clasps 22 disposed between teeth 13 and 16 when the oral appliance is worn.

In use, the oral appliance 10 may be placed into the jaw 50 so that the teeth 12; 13; 14; 15; and 16 may be received within respective dental impressions 26_{L} and 26_{R} and the body 24 held into place through bite pressure. In some exemplary embodiments, the ball clasps 22 may anchor the body 24 to the mandibular and/or maxillar sides of the jaw 50. The height profile H_{B} of the bridge 40 may create separation between the mandibular and maxillar incisors 12;14. The orifice 20 and the shelf 42 may be disposed to accommodate the tip of the tongue (not shown) to lie biased forward within the jaw 50 providing relaxation on the jaw muscles while simultaneously increasing patency in the oral breathing passage to the throat.

It should be understood, of course, that the foregoing relates to exemplary embodiments of the invention and that modifications may be made without departing from the spirit and scope of the invention as set forth in the following claims.

What is claimed is:

1. An oral appliance, comprising:
a molded body including left and right side members, the left and right side members each including a member width and lingual-side member walls; and
a rounded bridge connecting the left side member to the right side member, the bridge including a lingual-side bridge wall depressed from the lingual-side member walls, the bridge configured to accommodate a tongue between the lingual-side bridge wall and between the left and right side members in a relaxed state, the bridge including a bridge width narrower than the member widths.

2. The oral appliance of claim 1 further comprising:
a first set of impressions configured to receive teeth on the mandibular side of the left and right side members; and
a second set of impressions configured to receive teeth on the maxillar side of the left and right side members.

3. The oral appliance of claim 2 further comprising a non-uniform ridgeline along the first and second sets of impressions disposed to at least partially cover teeth received in the first and second set of impressions.

4. The oral appliance of claim 3 wherein the bridge includes a height profile below the ridgeline of the first and second sets of impressions.

5. The oral appliance of claim 1 further comprising a shelf configured to support a tip of the tongue on either a mandibular or maxillar side of the bridge.

6. The oral appliance of claim 1 further comprising dental anchors on the left and right side members disposed to attach onto teeth.

7. An oral appliance comprising:
a one-piece body including dental impressions molded into the body;
walls projecting from the dental impressions configured to at least partially cover anterior surfaces of cuspid, pre-molar, and molar type teeth while leaving exposed anterior surfaces of incisor type teeth; and
a bridge between two sets of the dental impressions, the bridge disposed to support the incisor type teeth, the bridge defining a lingual-less space between the cuspid type teeth and behind the incisor type teeth.

8. The oral appliance of claim 7, wherein the bridge includes a height below the walls projecting from the dental impressions.

9. The oral appliance of claim 7, wherein the bridge includes a shelf below the walls projecting from the dental impressions, the shelf disposed to accommodate a tip of a tongue biased forward in a jaw retaining the oral appliance.

10. The oral appliance of claim 9, wherein the bridge includes a support wall disposed to cover either mandiubular or maxillar side incisors.

11. An oral appliance comprising:
a one-piece body including dental impressions molded into the body;
a left side and a right side of the body defining a first open space of a first curvature between them; and
a bridge portion connecting the left side and right side of the body, the bridge portion defining a second open space of a second curvature greater than the first curvature.

12. The oral appliance of claim 11 wherein the left side and right side of the body define a first radius of curvature between them and the bridge portion includes a lingual-side wall defining a second radius of curvature less than the first radius of curvature.

13. The oral appliance of claim 11 wherein the bridge portion extends in an arc between a left and right side cuspid type tooth.

14. The oral appliance of claim 12 wherein the arc of the bridge portion is less than an arc defined by the first radius of curvature.
